(19) United States
(12) Patent Application Publication
(10) Pub. No.: US 2004/0010444 A1
(43) Pub. Date: Jan. 15, 2004

(54) Automated infrared printed circuit board failure diagnostic system

(75) Inventors: Jean-Francois Delorme, Montreal (CA); Salim Djeziri, Montreal (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Photon Dynamics, Inc., San Jose, CA

(21) Appl. No.: 10/419,041

(22) Filed: Apr. 17, 2003

Related U.S. Application Data
(60) Provisional application No. 60/373,340, filed on Apr. 18, 2002.

(51) Int. Cl. G06F 17/60

(52) U.S. Cl. 705/11

(57) ABSTRACT

There is described an infrared (IR) verification system comprising an IR imaging system for capturing thermal signatures, an IR image comparison engine to determine whether a fault exists, a database for thermal failure patterns of printed circuit board assemblies (PCBA) and their proposed diagnosis, and a correlation module to correlate the failure pattern to the database. There is also described a method for using the described system.

### CROSS-REFERENCES TO RELATED APPLICATIONS

The application claims priority to U.S. provisional application Serial No. 60/373,340 filed on Apr. 18, 2002 and entitled “Automated Infrared Printed Circuit Board Failure Diagnostic System”, the content of which is incorporated herein by reference in its entirety.

### STATEMENT AS TO RIGHTS TO INVENTIONS MADE UNDER FEDERALLY SPONSORED RESEARCH OR DEVELOPMENT

Not applicable

### REFERENCE TO A “SEQUENCE LISTING,” A TABLE, OR A COMPUTER PROGRAM LISTING APPENDIX SUBMITTED ON A COMPACT DISK.

Not applicable

### BACKGROUND OF THE INVENTION

The present invention relates generally to the field of industrial inspection, more particularly to industrial inspection of manufactured objects, such as printed circuit board assemblies (PCBAs), from which images are acquired and analyzed automatically to detect defects as a quality control prior to product delivery.

It is known in the art that an object such as an electronic PCBA may be inspected for defects by a procedure wherein said PCBA is electrically stimulated. Such stimulation may be due to the application of power as a minimum and possible additional application of signal inputs or some combination thereof, in order to obtain an infrared (IR) image via an IR camera. The pattern of heating of the PCBA under such stimulated conditions is referred to as the thermal signature of the PCBA. The captured image is compared to a reference thermal signature derived from known defect-free PCBA, in order to evaluate the quality of the connections, junctions, and components, on the PCBA under test.

This is possible because the presence of defects will generally cause some parts of the PCBA to operate either hotter or colder than normal when electrically stimulated, thereby appearing anomalous when compared against the thermal signature of a defect-free PCBA. This technique is thus very useful to identify the presence of defects on a PCBA. However, for many cases, it may take a skilled technician to diagnose the pattern of anomalies to determine the specific defect or defects contained on the PCBA and to repair it, or to disposition the PCBA for repair by another technician. The anomalous thermal signature indicates that the PCBA is not functioning normally, hence indicating the presence of a fault or faults. However, it does not necessarily isolate the fault since anomalous behavior in a component can be the result of an effect of another defective component or interconnection. Therefore, it is not obvious in all cases how the repair should be performed.

Thus, although this system is efficient in identifying faulty product, an efficient method to diagnose the fault is lacking. Efficient and effective disposition of faulty PCBA is often the most time consuming step in PCBA repair. Efficient and effective failure analysis and defect root-cause determination is also essential for process improvement and timely implementation of corrective action on the production line.

### BRIEF SUMMARY OF THE INVENTION

According to a first aspect of the present invention, there is provided an IR verification system comprising an IR imaging system for capturing thermal signatures, an IR image comparison engine to determine whether a fault exists, a database for thermal failure patterns of PCBAs and their proposed diagnosis, and a correlation module to correlate the failure pattern to the database. The system also comprises a barcode reader to associate a faulty PCBA with its thermal failure pattern in the database.

According to a second aspect of the present invention, there is provided a method for diagnosing a failure on a PCBA comprising providing a database, the database comprising thermal signature data files for faulty PCBAs and their associated diagnosis; capturing a thermal signature of a PCBA; comparing the thermal signature to a reference default free thermal signature; if a fault is identified, correlating the database to find a similar thermal signature data file; and retrieving the associated diagnosis.

When a thermal signature is not found in the database, it is recorded as a new entry and its associated diagnosis is entered after the diagnosis and repair is completed.

According to a third aspect of the present invention, there is provided a method for identifying a faulty PCBA in a production line, diagnosing the defect or defects causing the failure, recording the diagnosis and remedy, and compiling a statistical analysis pertaining to defect frequency and cause in an appropriate report format for improved monitoring and manufacturing process improvement.

According to a fourth aspect of the present invention, there is provided a method for manufacturing a PCBA. A database comprising thermal signature data files for faulty printed circuit board assemblies and an associated diagnosis is provided. A thermal signature of said printed circuit board assembly is then captured. The thermal signature is compared to a reference defect free thermal signature and if a fault is identified, the thermal signature is correlated to the database to find a similar thermal signature data file. The associated diagnosis is then retrieved from the database, and it can be used in a decision to repair or not repair the board. If the decision is to repair the board, the diagnosis can then be used in a repair strategy.

### BRIEF DESCRIPTION OF THE DRAWINGS

These and other features, aspects and advantages of the present invention will become better understood with regard to the following description and accompanying drawings wherein:

FIG. 1 is a block diagram of the apparatus according to the preferred embodiment;

FIG. 2 is flow chart of the method according to one embodiment of the present invention.

FIG. 3 is a flow chart of the method according to another embodiment of the present invention.

### DETAILED DESCRIPTION OF THE INVENTION

While illustrated in the block diagrams as ensembles of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

The system of the present invention is a thermal failure pattern recognition system for a PCBA linked with a cause identification database. The system determines if a PCBA is faulty, finds a similar type of fault based on IR images, suggests repair strategies for the fault identified, and maintains a statistical fault database that is used to provide periodic fault and yield reports for manufacturing process improvement. The system also maintains a database of IR images and correlation results associated with all failed PCBAs so that said information may be retrieved for PCBA repair by a technician at a later time.

To create an efficient system skilled technicians first build a database for each PCBA design and that associates thermal failure patterns with known defects, their causes and repair instructions. Said repair instructions may also include additional specified bench tests or other tests to verify the diagnosis. As the database is built-up, as additional different types of failure patterns are identified, the greater becomes the ability of the system to diagnose faults. The IR verification system is used to build the database. As the thermal signature is determined for a specific faulty PCBA, it is entered into the failure pattern database along with instructions for its repair. This information comprises the proposed diagnosis for the identified failure.

As failure patterns and associated repair instructions are entered into the database, the system can be used to provide lower skilled technicians with an automated diagnosis of the faulty PCBA for the known failure patterns. Once the system learns substantially all, or the majority of all, the failure patterns for defects typically occurring for a specific PCBA design on a specific production line, the system will perform substantially all, or a majority of all, fault diagnosis for the less skilled technician, automatically. An IR verification system is used to capture IR images of a PCBA under test and determines if the PCBA is faulty. If so, the system then correlates the database with the failure pattern to locate a similar failure pattern, thus indicating a probable similar failure. The proposed repair instructions associated with the failure type are retrieved and the lower skilled technician can repair the faulty PCBA according to these instructions.

It may happen that the system scans the database and does not find a match for the failure pattern. In this case, the new failure can be recorded into the database as a new entry.

The system also indicates the confidence level of the suggested diagnosis. An observed failure pattern may correlate with a number of known failure patterns within the failure pattern database to varying degrees. A list of probable faults above a specified degree of correlation (i.e. level of confidence or goodness of fit) is presented to the technician in rank order. Further, there may be more than one fault associated with a particular failure pattern. In this case, the system would list the multiple defects that could possibly cause the observed failure pattern, along with associated diagnostic information. Such sub-listing would rank the possible failures depending on their frequency of occurrence.

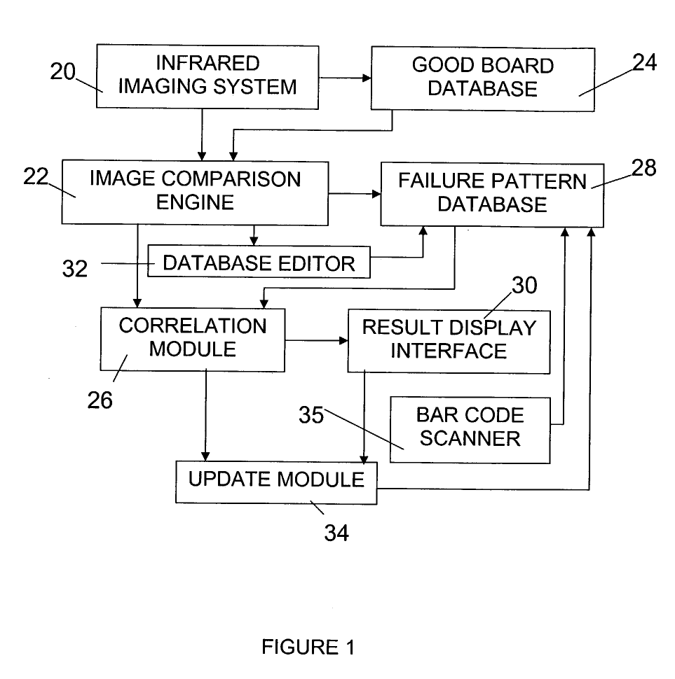

FIG. 1 is a diagram of various blocks disposed in a system, in accordance with one embodiment of the present invention. An IR imaging system 20 is used to capture IR images. An IR image comparison engine 22 compares the captured images with reference defect-free images derived from a good PCBA database 24 and determines if a fault is present. If a defect or a fault is detected, the image comparison engine 22 transfers the failure pattern of the faulty PCBA to a correlation module 26 and accesses the failure pattern database 28 to determine if there exists a match to the failure pattern of the faulty PCBA. The repair information or proposed diagnosis for the identified faulty PCBA is then extracted by the correlation interface and transferred to a result display interface 30. If the results indicate that there is no match found in the failure pattern database, the thermal signature is recorded as a new entry into the failure pattern database 28 via the database editor 32. A skilled technician can inspect the faulty PCBA at a later time and enter the associated diagnostic using the database editor 32.

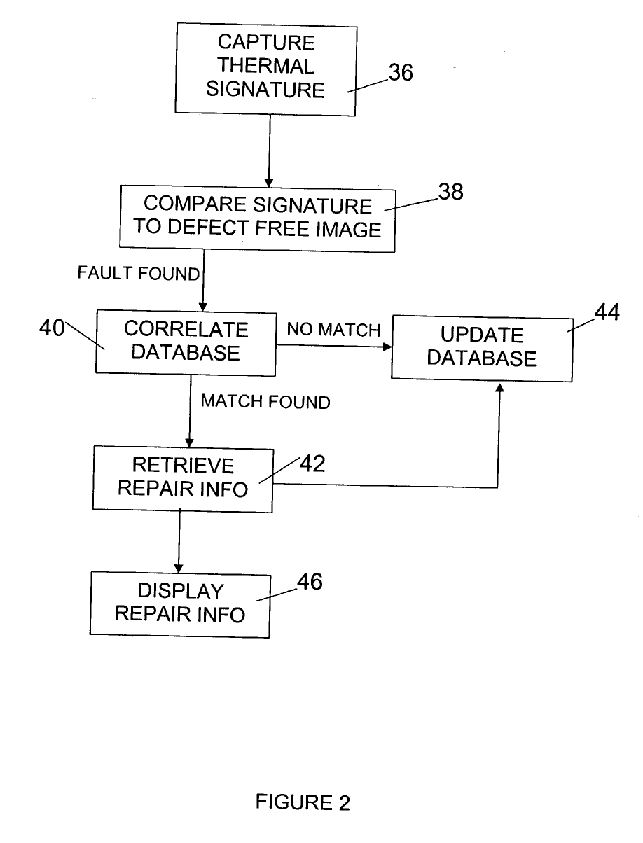

FIG. 2 shows steps of a method performed in accordance with one embodiment of the present invention. Thermal signatures are captured using an IR imaging system in step 36. In step 38, the images are compared to defect-free reference images. In the case of a faulty PCBA, in step 40 a database is scanned for a match to the thermal failure pattern of the faulty PCBA. If a match is found, in step 42 the repair information is retrieved. If no match is found, the new failure pattern is recorded into the database as a new entry in step 44. Optionally, the results are displayed on a display interface in step 46. The database can also be updated after a fault has been confirmed. This can be done manually by a technician or in some automated manner. The database is updated to reflect the new occurrence of the faulty signature.

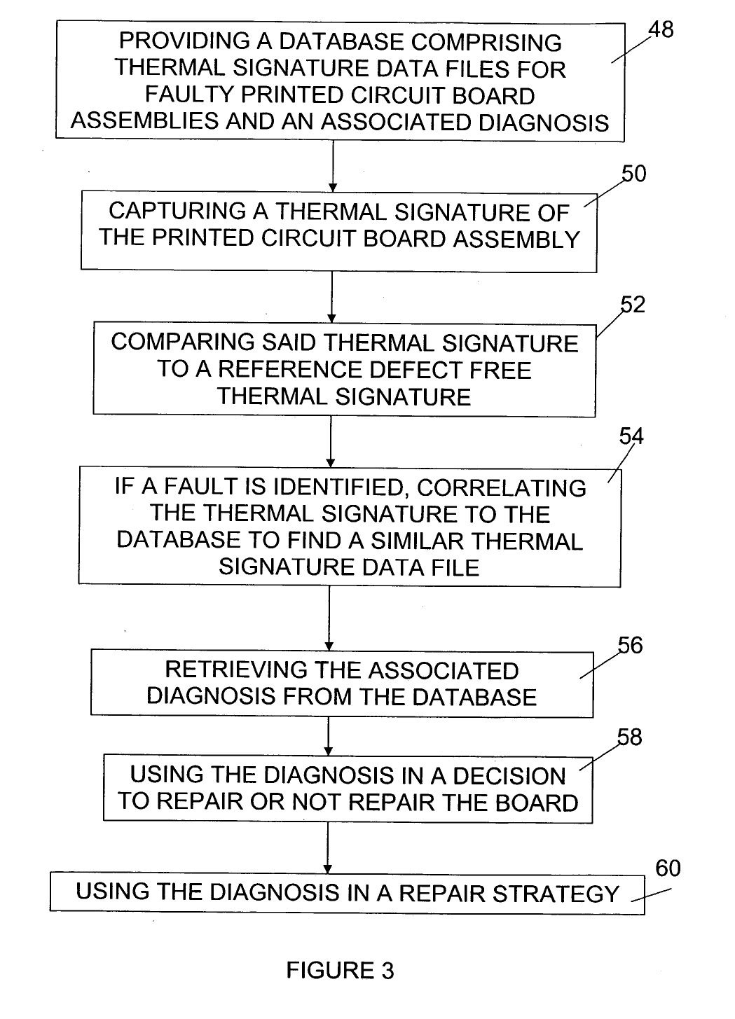

FIG. 3 also shows steps of a method performed in accordance with one embodiment of the present invention. In step 48, in order to manufacture a PCBA, a database comprising thermal signature data files for faulty printed circuit board assemblies and an associated diagnosis is provided. In step 50, a thermal signature of said printed circuit board assembly is then captured. In step 52, the thermal signature is compared to a reference defect free thermal signature. If a fault is identified, the thermal signature is correlated to the database to find a similar thermal signature data file in step 54. The associated diagnosis is then retrieved from the database in step 56, and it can be used in a decision to repair or not repair the board in step 58. If the decision is to repair the board, the diagnosis can then be used in a repair strategy in step 60.

One embodiment of the correlation is as follows: Regions in IR images that are warmer or cooler than an acceptable tolerance level are identified as failure patterns. These regions are characterized by their exact area location, centroid location, area, circumference, elongation and other morphological properties. These properties are compared to the properties of failure patterns stored in a database where those patterns are associated to a previous diagnostic. The correlation is a mathematical calculation of the degree of similarity of failure patterns that could be done by a function that calculates a weighted sum of property similarity.

One such database contains a number of good PCBAs to generate a model for comparison. Another database will contain original IR time sequenced images, failure pattern images, exact area location, centroid location, area, circumference, elongation and other morphological properties of the failure patterns. This database will contain also diagnostics of faulty electronic circuits associated with the failure pattern. These diagnostics could include the cause of the problem and the process to fix it including any diagnosis verification procedures.

Alternatively, a second embodiment of the correlation is as follows: Individual pixels in the IR images that are warmer or cooler than an acceptable tolerance level are identified as anomalies. These images are directly compared to images stored in a database where those images are associated to a previous diagnostic. The correlation is a mathematical calculation of the degree of similarity of failure patterns as described by the value of the computed correlation coefficient.

One database associated with the second embodiment contains a number of good PCBAs to generate a model for comparison. Another database will contain original IR time sequenced images and corresponding IR time sequenced images containing known failures. This database will contain also diagnostics of faulty electronic circuits associated with the failure pattern. These diagnostics could include the cause of the problem and the process to fix it including any diagnosis verification procedures.

Alternatively, a third embodiment of the correlation is as follows: Components in IR images that are associated with regions that are warmer or cooler than an acceptable tolerance level are identified as anomalies. The resulting pattern of anomalous components is compared to patterns of anomalous components that are stored in a database where those patterns are associated to a previous diagnostic. The correlation is a mathematical calculation of the degree of similarity of failure patterns that could be done by a function that calculates a weighted sum of property similarity.

One database associated with the third embodiment contains a number of good PCBA's to generate a model for comparison. Another database will provide component location in terms of pixel address associated with the IR image. Another database will contain original IR time sequenced images and corresponding patterns of anomalous components that are associated with known failures. This database will contain also diagnostics of faulty electronic circuits associated with the failure pattern. These diagnostics could include the cause of the problem and the process to fix it including any diagnosis verification procedures.

The information may be given to the technician as a list of proposed diagnostics showing title with a corresponding level of confidence, for example:

| | |
|---|---|
| Reverse capacitor C4 | 82% |
| Missing pull-up resistor R32 | 42% |
| U23 EEPROM not programmed | 12% |
| Missing Voltage Regulator | 3% |
| Short between R21 and R22 | 1% |

The technician is able to select a proposed diagnostic title and view a more elaborate description of the problem, including associated IR images and failure patterns and associated repair instructions and verification procedures.

Additionally, the system can comprise further intelligence. The failure pattern database may be in a constant state of learning. As each new PCBA is inspected and identified as faulty, the system proposes a list of probable causes to the user, each with a level of confidence indicating what the likelihood associated to each cause is. Once the technician performs the repair, the information relating to the actual repair, and as a minimum confirming the actual cause and possible modifications to the repair instructions and verification procedures, is entered into the system via the result display interface or the database editor.

For example, using the example described above, if after examining the PCBA more closely, the technician determines that the problem is actually the short between R21 and R22, this information is entered into the system. An updating module then updates the information in the failure pattern database to reflect the new entry, and in this manner tracks the frequency of occurrence of this failure. The confidence level or ranking of the fifth proposed solution may be increased in consideration of the number of PCBAs having had the faulty thermal signature identified—assuming the fault is in fact a short between the two resistors. The next time this failure pattern is matched to a faulty PCBA, the list displayed to the technician comprising the proposed solutions will remain the same, but the confidence levels of the diagnostics will have changed.

The frequency of occurrence of information can thus be used as a component in the computation of the level of confidence for a particular failure, or be presented as a separate statistic in addition to a measure of correlation, both measures contributing to the level of confidence for a particular failure. The frequency of occurrence measure, which may be presented as a percentage of total defects, among other means, is a particularly valuable measure when evaluating multiple failures associated with a common failure pattern, and when evaluating complex failure patterns composed of multiple failures. For example, two separate failures may cause a common failure pattern, for example, a lifted lead on a component preventing the component from receiving power and the backward placement of the component, may both show the component to be anomalously cold. In this case historical data may show that in 90% of the instances when this failure pattern is observed it has been caused by the lifted lead, and in 10% of the instances when this failure pattern is observed it has been caused by the misplaced component. Accordingly, the lifted lead failure will be presented to the technician as a higher probability failure, or with a higher level of confidence, than the backward component failure.

Situations may occur when a PCBA is identified as faulty, and the failure pattern is matched to entries in the database, and a list of probable faults is shown to the technician, but none of the listed faults are the cause of the observed failure. This may happen every time that a specific fault is observed for the first time. Once this first time fault has been identified, it is entered into the system and the update module will update the failure pattern database to include the newly observed fault, this fault being ranked with a very low frequency of occurrence, in view of its first occurrence, as a cause of a fault for that particular failure pattern, for a mature database. However, it is appreciated that the next failure may display a failure pattern that is highly correlated with the new found fault leading to a high level of confidence even though there is a low frequency of occurrence. It is noted that as production of a particular PCBA begins and a fault database is built-up, all faults may have a low frequency of occurrence. FIG. 1 indicates the presence of an additional component to the system, an update module 34. Frequency of occurrence data is a particularly valuable reporting parameter for manufacturing process monitoring and control.

As is seen from FIG. 1, in one embodiment, the system also comprises a barcode reader or scanner 35. Each PCBA is identified with a barcode. When the database is built, all of the information is indexed to the barcode of the associated PCBA. When a match is found between thermal signatures, the technician may wish to view the matching failure pattern images and look at suggested diagnostics and proposed solutions to repair the faulty PCBA.

It may happen that the system scans the database and does not find a match for the thermal signature. In this case, the new failure can be recorded into the database as a new entry. Its barcode can be scanned and associated with the new entry. If the repair to be done is beyond the capabilities of the lower skilled technician, then the barcode will allow a high skilled technician to locate the PCBA at a later time, perform the repair, and enter the repair information into the database.

It should be noted that the present invention can be carried out as a method, can be embodied in a system, a computer readable medium or an electrical or electromagnetic signal.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following the principles of the invention and including such departures from the present disclosure as come within known or customary practice within the art to which the invention pertains and as may be applied to the essential features hereinbefore set forth.

What is claimed is:

1. An infrared verification system comprising:
a failure pattern database for thermal failure patterns of printed circuit board assemblies and their proposed diagnosis;
an infrared imaging system for capturing thermal signatures of printed circuit board assemblies under inspection;
an image comparison engine to compare said printed circuit board assemblies under inspection to a model for comparison to generate one of a pass and a fail of said captured thermal signature; and
a correlation module to correlate said captured thermal signature in the case of a fail to said thermal failure patterns in said failure pattern database and when a matching thermal failure pattern is found, retrieve a diagnosis associated to said matching thermal failure pattern.

2. The system as claimed in claim 1, further comprising a barcode reader to associate a faulty board with a corresponding thermal failure pattern in said database.

3. The system as claimed in claim 1, further comprising a good board database comprising a plurality of known defect free printed circuit board assemblies to generate said model for comparison, said good board database transmitting said model to said image comparison engine for comparing to said thermal signatures.

4. The system as claimed in claim 1, further comprising a result display interface for receiving data from said correlation module and displaying said data.

5. The system as claimed in claim 1, further comprising a database editor for adding new thermal failure patterns to said failure pattern database based on data received from said image comparison engine.

6. The system as claimed in claim 1, further comprising an update module for updating said failure pattern database based on data received from said correlation module.

7. A method for diagnosing a failure on a printed circuit board assembly comprising:
providing a database, the database comprising thermal signature data files for faulty printed circuit board assemblies and an associated diagnosis;
capturing a thermal signature of said printed circuit board assembly;
comparing said thermal signature to a reference defect free thermal signature;
if a fault is identified, correlating said thermal signature to said database to find a similar thermal signature data file; and
retrieving said associated diagnosis from said database.

8. The method as claimed in claim 7, wherein when a thermal signature is not found in said database, an analysis is performed on said printed circuit board assembly to determine a diagnosis, and said thermal signature and said diagnosis is recorded as a new entry into said database.

9. The method as claimed in claim 7, wherein when a thermal signature is found in said database, said database is updated by incrementing a number of occurrences of said thermal signature for statistical purposes.

10. The method as claimed in claim 9, further comprising yielding statistical reports of statistics representing faulty thermal signatures in said database.

11. The method as claimed in claim 7, further comprising displaying said associated diagnosis.

12. The method as claimed in claim 11, wherein said displaying comprises displaying a confidence level corresponding to said diagnosis.

13. The method as claimed in claim 12, wherein said confidence level is based on a frequency of occurrence of a fault associated with said diagnosis.

14. The method as claimed in claim 13, wherein said confidence level is updated after a repair has been completed by confirming that a diagnosis corresponds to an associated thermal signature.

15. The method as claimed in claim 11, wherein said displaying comprises suggesting a repair strategy for said diagnosis.

16. The method as claimed in claim 7, wherein said database is built using said infrared verification system.

17. The method as claimed in claim 11, wherein said displaying comprises displaying a plurality of possible diagnostics associated with a thermal signature.

18. The method as claimed in claim 17, wherein said displaying comprises displaying a confidence level associated with each of said possible diagnostics.

19. The method as claimed in claim 17, wherein a user selects one of said possible diagnostics.

20. The method as claimed in claim 19, wherein said user updates said database by indicating which of said possible diagnostics corresponded to a detected fault.

21. A method for manufacturing a printed circuit board assembly comprising:
providing a database, the database comprising thermal signature data files for faulty printed circuit board assemblies and an associated diagnosis;
capturing a thermal signature of said printed circuit board assembly;
comparing said thermal signature to a reference defect free thermal signature;
if a fault is identified, correlating said thermal signature to said database to find a similar thermal signature data file;
retrieving said associated diagnosis from said database;
using said diagnosis in a decision to repair or not repair the board.

22. A method as claimed in claim 21, wherein said diagnosis is used in a repair strategy.
